(19) United States
(12) Patent Application Publication
(10) Pub. No.: US 2004/0230524 A1
(43) Pub. Date: Nov. 18, 2004

(54) Charity bundling site

(76) Inventor: Matt Meiners, Sunset Beach, CA (US)

Correspondence Address: LAW OFFICES OF CLEMENT CHENG, 17220 NEWHOPE STREET #127, FOUNTAIN VALLEY, CA, 92708, US

(21) Appl. No.: 10/436,674

(22) Filed: May 13, 2003

(51) Int. Cl. G06F 17/60

(52) U.S. Cl. 705/40; 705/35; 705/34

(57) ABSTRACT

The present invention relates to a method for electronic processing of online electronic fund transfers for charity donations, and more particularly the method comprises the steps of: providing information on a CBS website to receive user input settings, wherein user input settings are stored in a database; instructing users to return to their Bill Pay Site to select CBS, wherein CBS is a registered payee on a Bill Pay Site; sending electronic bills from the CBS host computer to user Bill Pay Site computers, wherein the payment amount is automatically entered for the user on the Bill Pay Site and stored on the Bill Pay Site computer; calculating monthly charity donation amounts, one EFT to each payee charity.

### BACKGROUND OF INVENTION

Charitable organizations face inefficiencies processing monthly donations. Inefficiencies compound when many charitable contributions arrive in a series of checks in small amounts. While trying to provide humanitarian aid and services to local communities, charitable organizations must divert their time and resources to administrative tasks. Charities often rely on volunteers inexperienced in bookkeeping and must spend a portion of their contributions to hire administrative staff to operate paper systems and remind donors of pledge obligations.

Charitable organizations frequently receive pledges for monthly donations, but suffer from an inefficient means of collecting charitable donations. Charities are frustrated by donor forgetfulness, while donors are hassled with remembering to send a monthly check.

Donors may make charitable donations via Internet by electronic fund transfer (EFT), but only after tedious entry of personal financial information for each individual charity. Traditionally, each charity must maintain electronic fund transfer transaction management systems and accounts. Donors are also limited in charitable donations via EFT as some charities do not have the staff to set up electronic fund transfer accounts on a regular basis. Because of the paper and electronic paperwork involved, sending EFT contributions to numerous charities becomes very inefficient.

All charities currently request personal financial information from the donor send monthly reminders and receive EFT payments. Unfortunately, public disclosure of personal information to charities leaves the donor vulnerable to their personal information being sold to other charities, resulting in a barrage of mail from other charities seeking support.

Current Electronic Payment Systems and Bill Pay Sites

The Internet allows efficient online billing and EFT payments for commercial transactions through various financial companies and e-commerce services. Bill Pay Sites are website services that direct provide online billing and EFT payment.

Internet commerce has become a common means to bill and issue payments. Online billing and payments may be conducted through Bill Pay Sites provided by financial institutions or other electronic commercial services. Bill Pay Sites automatically pay monthly bills via EFT. Account information and personal background information, such as the user's name, address, social security number need only be entered once for registration with a Bill Pay Site for electronic financial transactions. Bill Pay Site EFT can also pay certain payees that are not registered on the pick list, but this requires a user to manually enter the payee financial information.

Each user is assigned a Bill Pay Site ID number. The user selects payees and participating organizations from a pick list. This selection of specific participants will be included in the billing cycles of the Bill Pay Site. The user selection of participating organizations also called registered payees notifies the registered payee to send an electronic bill to the bill pay site. Users also have the option of establishing a recurring payment that is the same amount each month.

Registered payees have supplied their information to the bill pay site so that users do not need to know or enter this information. Registered payees send electronic bills to the bill pay site and users select payees for payment. In some embodiments, a user simply accesses the bill pay site regularly and clicks a check box in front of a billing summary to pay the bill. Because electronic bills automatically enter the amount to be paid in a total payment field, users seldom submit a wrong amount.

Different billing companies, such as credit card companies, cable companies, and phone companies, use Bill Pay Sites to send monthly electronic bills to customers. The Bill Pay Site allows the user to consolidate all their electronic bills and monthly electronic payments through one web site rather than track bills and payments through separate sites for each individual bill. Also, the Bill Pay Site allows users to track the history of their electronic bill payments with ease.

Complex encryption algorithms offer security and verify the identity of the user and authentication of participating payee organizations. Many registered payee participating companies may directly correspond by telephone and in person to verify identity.

Unfortunately, the vast majority of bill pay sites are unable to list a large number of charities due to the economies of scale involved. Some charities are not well known and thus not registered at a bill pay site, yet some users would like to send these charities a monthly donation by EFT.

### OBJECTS OF INVENTION

The first object of the invention is to avoid asking a user for personal financial information when accessing the Charitable Bundling Site for automating payments of monthly reoccurring donations.

The second object of the invention is to provide an automated e-commerce system to make charitable contributions convenient and cost effective for the donor and charitable organizations.

### BRIEF DESCRIPTION OF DRAWINGS

FIG. 1 is a logical flow chart showing operation of the invention.

FIG. 2 is a flow chart showing the flow of money from donors to the charity bundling site, to charities.

FIG. 3 is a chart showing the steps involved in the flow of money from donors to the charity bundling site, to charities.

FIG. 4 is results page

FIG. 5 is an order page

### SUMMARY OF THE INVENTION

The Charity Bundling Site works in cooperation with major Internet bill pay sites such as Bank of America, MSN.com, and Checkfree.com. Since it is not feasible for these and other bill pay sites to list a large number of charities on their bill pay sites, a Charity Bundling Site works with these organizations as a bundling site to list and organize monthly donations directly from internet bill pay site users. The service allows bill pay site users to choose from the Charity Bundling Site list, the charity or charities they would like to pledge to donate to by EFT each month. Since the user accesses the Charity Bundling Site directly from their bill pay site, there is no need for the user to input any financial data.

Research shows that as many as 75% of potential donors exit a charitable site once the site has asked for their financial information. Since the Charity Bundling Site eliminates that step, a much greater percentage of end users will result. Once the bill pay site user makes their choice at the Charity Bundling Site, they simply return to their bill pay site, and add Charity Bundling Site as a regular reoccurring monthly payee. Each month as the user pays their bills they also authorize their pledged payment to Charity Bundling Site.

The Charity Bundling Site in turn funnels the funds directly to the bank account of the chosen charity. Making these monthly electronic transfers directly to the charity's bank account eliminates the need to handle paper checks and in turn cuts down on the various costs associated with handling paper checks. Since the Charity Bundling Site works closely with the major bill pay sites, the Charity Bundling Site is able to perform these important monthly transfers for a very small fee. On the average $19.55 of ever $20.00 donated will be deposited directly to the chosen charity. Charity Bundling Site will handle the process of tracking the donor and the dollar amount donated, along with the automatic control that occurs at the bank, and the Charity Bundling Site will with the charity's cooperation issue an annual receipt for the donor.

### DETAILED DESCRIPTION OF PREFERRED EMBODIMENT

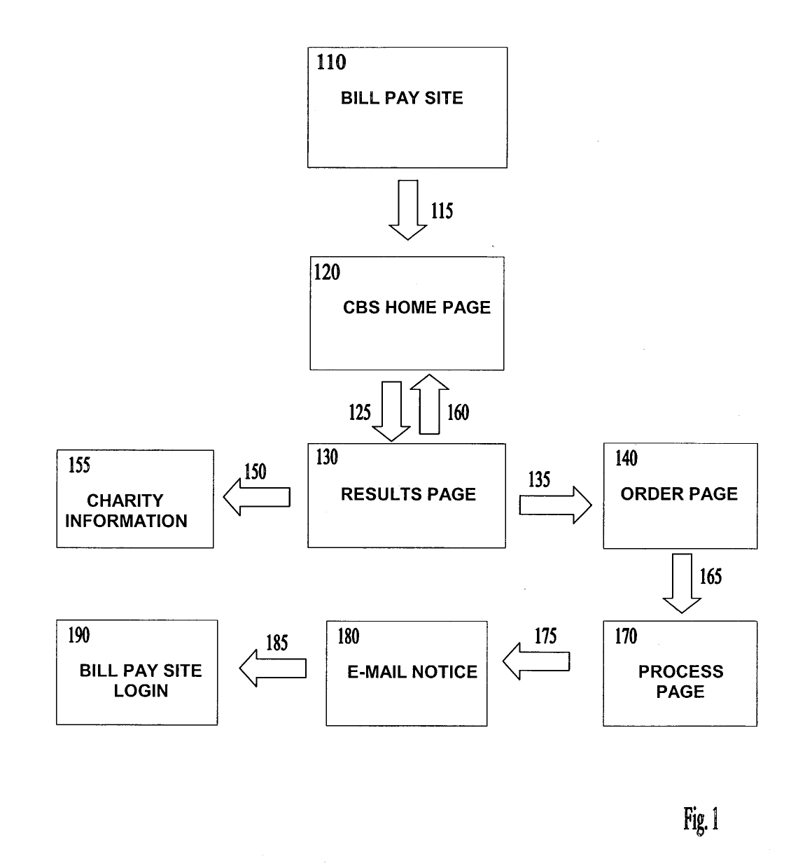

In the present invention, the Charity Bundling Site complements existing electronic financial services offered by online billing and payment sites known as Bill Pay Sites (BPS). As previously discussed, a BPS is a web site having a user account and user account information where the users give the BPS authorization to deduct money from their user bank accounts and use that money to pay payees by online electronic fund transfer (EFT). FIG. 1 shows the process and integration of the Charity Bundling Site (CBS) 120 linked to Bill Pay Sites 110. Bill Pay Sites 110 registered users consolidate bill payments on the Internet to receive e-bills and send electronic fund transfer (EFT). Oftentimes, the user does not pay a charge for the use of Bill Pay Sites 110. The transfer costs and charges are deducted from the total amount to be transferred to the payee.

The various payees such as utilities, credit card companies and related consumer companies register with the BPS by providing their financial information to the BPS. Financial information includes data necessary for completion of an EFT such as a bank routing number, bank account number, and name of payee. Once registered, the BPS offers to users various registered charities on a BPS pick list. Having a pick list eliminates the need to obtain the financial information of the payee. Financial information corresponding to the payee's name on the pick list can be entered automatically by the BPS. When a user registers with the BPS the user need only input their financial information one time and pick a number of registered payees from the pick list. The user may then pay the payees automatically each month.

The Charity Bundling Site is set up as a payee on the BPS pick list. The user first arriving at the CBS need only register by identifying himself by a CBS account number that can be an e-mail address, a user name, or a randomly assigned account number. Because a computer can convert a user name or an e-mail address into a number, a wide variety of unique identifiers are acceptable. Once the user has a CBS account number, the user creates a registry of donations saved on user settings data base on the charity bundling site. The user then returns 185 to the BPS 190 to authorize payment to the CBS trust account. The user does not give CBS any financial information such as banking routing number, banking account number, name of financial institution, or name of user on bank account.

The Bill Pay Site 110 provides a web hyperlink 115 to the CBS home page 120. The donor can browse CBS and search for charities in their area by providing their zip code or search for national charities by an alphabetical database provided on the home page of CBS 120. CBS maintains a registry of charities for each donor registered at a BPS.

As a result of the web search 125, the “Results Page” 130 will show a list of local charities according to the zip code entered or national charity selected from the database. From the “Results Page” 130, the user can click on, “More Info,” “Add,” “Finish,” or “Cancel.” The “More Info” tab 150 will lead to a separate web page allowing users to read a description of the selected charity 155, and often provide a link to the selected charity website. Alternatively, the donor may return to the CBS home page 120 by clicking on the “Cancel” button 160 and conduct another search. If the donor chooses a selected charity, the donor may click the “Add” button 135 to access the “Order Page” 140.

On the “Order Page” 140, the donor designates the monthly donation amount to the selected charity. The name of the charity and an empty text box will appear on the “Order Page” 140. After entering the desired amount in the text box, the donor can either add this monthly donation to other existing monthly donations by clicking on the “Add” button 165, or cancel the transaction and return to the “Results Page” by clicking on the “Cancel” button 145. A donor may add and remove charities from the CBS charity registry list.

Once the donation(s) is/are complete, the order is sent to the “Process Page” 170. At this stage, the order information is recorded into a database. An online confirmation and receipt is issued to the donor. Then, the donor is instructed to either print out the Process Page or write out the account number of the charity or charities selected for their records. An option to input the donor's e-mail address will appear. The donor may receive an annual statement of donations by listing an e-mail address. Further, a disclaimer is included and states the e-mail address provided by the donor will not be sold or transmitted to outside parties.

On the “Process Page” 170, the donor is instructed to access their Bill Pay Site 110 and register CBS from the pick list. The pick list provides a list of billing company payees registered with the Bill Pay Site.

By designating the Charity Bundling Site as the payee for all charity donations, the donor instructs the Charity Bundling Site host computer to: receive the donor's funds into the trust account; transfer the funds to the charity; and record all transactions for future reference if requested by the donor. When the donor accesses the Process Page, an “E-mail Notice” 180 is automatically sent 185 to the charity so that the payment can be identified by the charity when it is forwarded by the Bill Payment Site. The charities receiving the funds will send a tax receipt e-mail to the user confirming payment has been received.

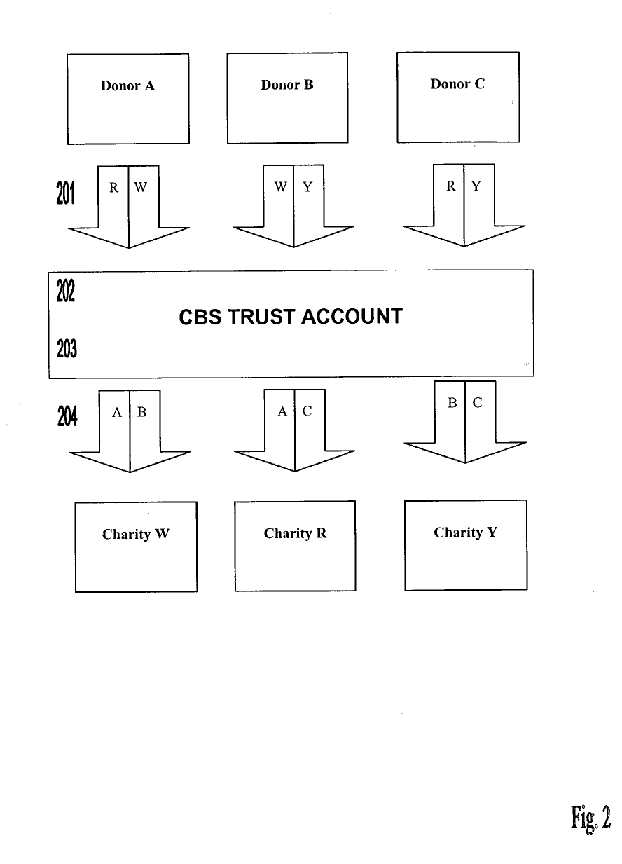

FIG. 2 further illustrates the processing and calculation of fund transfers from donors to the Charity Bundling Site 201, then from the Charity Bundling Site to charity payees 204. Donor payors send money according to their user defined settings for their monthly contribution 201. They send the money to the charity bundling site through their bill payment site 201. The CBS receives payments from each of the donors 202. CBS matches the amount received from the payor to the user defined settings on the charity donation registry and designates amounts to each of the CBS payees according to user defined settings 203. All donations are cumulatively received into a trust account and after a set predetermined holding time of preferably 28 days, automatically dispersed in a lump sum amount to each charity 204 minus a small transactional fee.

During the 28 days, the money is held in trust 203. The CBS does not need to send an electronic bill showing details of the payment to the donor and having the correct amount filled out in the total amount field. Sometimes, errors occur in the system. If a user's user defined settings do not match the amount the BPS sends to the CBS, the CBS sends the user an email notice that the user defined settings may be incorrect and that the funds are being held in the CBS trust account. The user then has 28 days to rectify the problem. When the user returns to the CBS site to correct the problem, the funds are disbursed at the end of 28 days. If the user has designated a smaller amount than was actually transferred to the CBS, the CBS retains the additional funds and sends an email error notice to the user. The user may designate additional charities or request a refund of the additional amount. If the user takes no action, the CBS may automatically send an EFT to the user returning the additional funds at the end of 28 days.

If the user designated a higher amount than was transferred to the CBS, the CBS sends an e-mail notice to the user and requests that the user change the user defined charity registry settings to match the amount transferred to the CBS. The CBS retains the funds until the end of 28 days. If the user takes no action, the CBS may automatically send an EFT to the user returning the additional funds at the end of 28 days.

As a less desirable option, a user may select a pro rata option at the CBS order page by checking the “pro rata option” check box. The pro rata share option becomes a part of the charity registration user settings. If a user submits less money than was pledged in the user defined settings, the charity's automatically receive a pro rata share of the contribution. If a user submits more money than was pledged in the user defined settings, the charities automatically receive a greater amount which is still a pro rata share of the total contribution. For example, if a user pledges $25 to the Red Cross and $35 to the YMCA and the user submits a payment of $50, then $20.83 will be designated for the Red Cross and $29.17 will be designated for the YMCA.

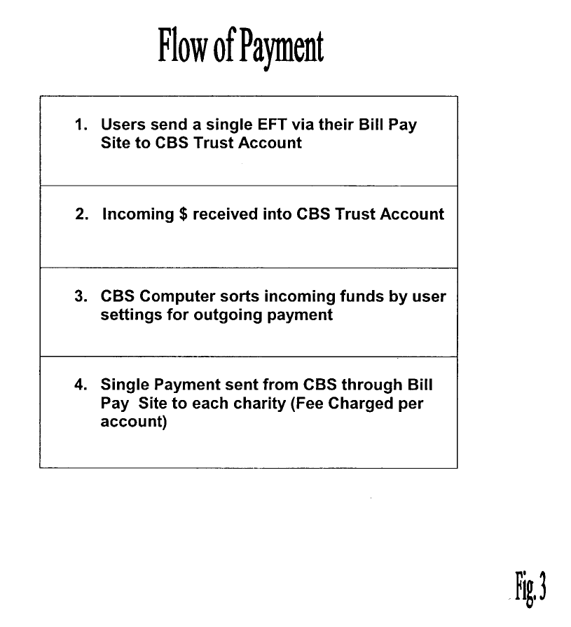

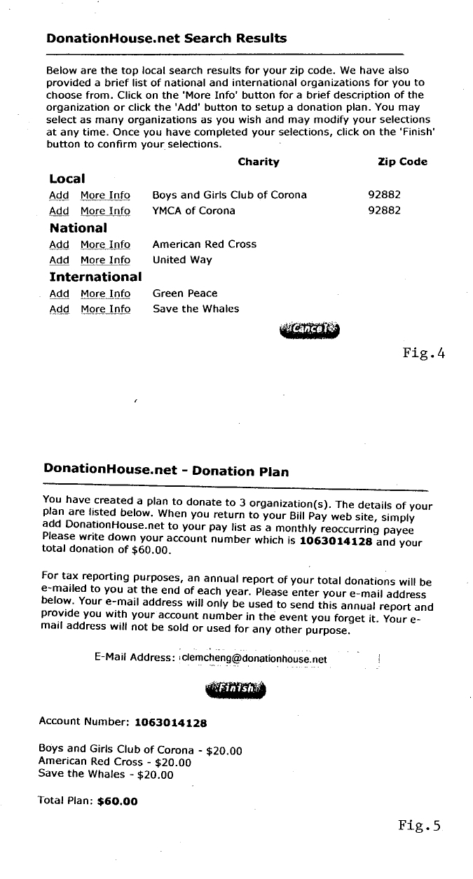

FIG. 3 specifically illustrates the process of the transactions and the flow of payment. As shown, the flow of payment begins at 1 with the donor inputting CBS account number information and designating amounts to specific charitable organizations from the Bill Pay Site to the CBS. The donor must manually register CBS in the Bill Pay Site to include CBS in the accounting database system. The CBS does not need to generate a bill to each donor based upon the user settings because the Bill Pay Site automatically generated a reminder to each donor and send payments to CBS trust account 2. Finally, CBS will consolidate all donations 3 and disburse donations in one lump sum amount from the trust account to each charitable organization minus a transactional fee 4. The transactional fee is a flat fee per transaction that is very small compared to the total donation amount to the charitable organization. The payment period may be a month or any other regular time. An example is shown in FIG. 2.

For example, three users by the name of Able, Baker and Charlie make donations each month to various charities. They are denoted as Donor A, Donor B and Donor C. The three charities are Red Cross, World Vision, YMCA. They are labeled as Charity W, Charity R and Charity Y.

Each Month:

Able wants to make a payment of $20 to Red Cross and $20 to World Vision.

Baker wants to make a payment of $20 to World Vision and $20 to YMCA.

Charlie wants to make a payment of $20 to Red Cross and $20 to YMCA.

Each month: Able, Baker and Charlie each pay CBS as a payee from their bill pay site in the amount of $40 each so that one $40 EFT per user is sent to the CBS trust account 201. Each $40 electronic fund transfer payment is designated for more than one charity. FIG. 2 represents the single electronic fund transfer as a single arrow having two designations, one for each charity. Donor A has an arrow designated with charity R and W representing the Red Cross and World Vision. Each electronic fund transfer payment has one or more designated charities. The three payments of $40 each totals $120. If the transaction fee charged by the Bill Pay site is 5 cents for each payment to CBS, then the Bill Pay transaction fee is 5 cents per person or 15 cents total.

CBS receives the money 202 which is now $39.95 per person and totals $119.85.

CBS allocates funds according to user settings in the CBS host server 203.

CBS charges a 0.40 handling fee per EFT and sends three EFT payments 204, one each to Red Cross, World Vision, and YMCA in the amount of $39.55 each. Each payment is sent through the Bill Pay site and costs another 5 cents so that each charity receives in its bank $39.50 per month. In FIG. 2 the single electronic fund transfer is again shown as a single arrow having two designations, one for each donor. Charity W has an arrow designated with donors A and B representing Able and Baker's donations. The arrow shows that a portion of the single EFT is attributable to Able's donation and a portion of the single EFT is attributable to Baker's donation.

At the end of each year, charities send receipts to the charity bundling site host computer. Users who so request receipts in their user settings receive the receipts by email. Because the charities receive only the user identification number without user contact information or user financial reformation, the user remains anonymous. Receipts are sent by charity computers to the charity bundling site host computer showing a user identification number, amount donated, and date of receipt of donations. The charity bundling site host computer receives the receipts and sends them to the user by e-mail. Because the charity bundling site host computer only has an e-mail address, user identification number, and the users' Bill payment site financial information, the charity bundling site issues a receipt without the user's financial information or contact mailing address.

The foregoing describes the preferred embodiments of the invention and modifications may be made without departing from the spirit and scope of the invention as set forth in the following claims.

Call Out List of Elements

FIG. 1

110. Bill Pay Sites

115. Web Hyperlink

120. Charity Bundling Site (CBS)

125. Web Search

130. Results Page

135. Selection

140. Order Page

150. More Information

155. Description of the Selected Charity

160. Cancellation

170. Process Page

180. E-mail Notice

190. Bill Pay Site Login

FIG. 2

201. Fund Transfers from Donors to the Charity Bundling Site through Bill Payment Site

201. Donor defines settings

202. CBS receives and matches payments

203. Donations being held in trust for 28 days

204. Fund Transfers from the Charity Bundling Site to Charity Payees.

FIG. 3

1. Users send EFT to CBS Trust Account

2. Incoming money received into CBS Trust Account

3. CBS consolidates and disburses donations

4. Payment sent from CBS through Bill pay Site to each charity

1. A method for electronic processing of EFTs for charity donations comprising the steps of:
a. establishing a charity bundling website on a host computer;
b. establishing a trust account bank account;
c. registering a charity bundling service as a payee on a pick list of a Bill Pay Site,
d. establishing a hyper link from a Bill Pay Site to a charity bundling site to direct Bill Pay Site registered users to the charity bundling site wherein Bill Pay Site registered users visit a charity bundling website;
e. configuring the host computer to generate a list of registered charities for selection by registered users;
f. generating a results page for a user comprising a list of charities the user selected and respective periodic donation amounts pledged to each charity; receiving registered user selections and recording the selections in a user setting database stored on the host computer;
g. the bill pay site automatically entering the financial information of the charity bundling service when a user selects the charity bundling service as a recurring payee at their Bill Pay Site;
h. configuring the host computer to assign users a user ID number;
i. receiving one donation per period per user into the trust account bank account;
j. configuring the host computer to receive all EFT information from the Bill Pay Site for all users in every regular period;
k. consolidating all EFT information for all users in the period, the electronic fund transfer information comprising a donation amount and a user ID number; recalling user settings by user ID number;
l. calculating charity donation amounts for each charity from user settings, wherein individual charities are allocated a sum of money equal to the total amount of donations allocated to them by users registered on the charity bundling site;
m. configuring the host computer to perform an error checking routine including comparing the electronic fund transfer amount received into the trust account bank account with the total of the pledged amounts in the user settings data base located on the host computer;
n. adding the pledged amounts for each charity in the user settings to the total amount to be transferred to each charity only if the EFT amount equals the total of the pledged amounts in the user settings database located on the host computer;
o. sending EFT instructions from the host computer of the calculated charity donation amounts from the trust account bank account as one electronic fund transfer for each charity after a predetermined number of days.

2. The method for electronic processing of EFTs for charity donations of claim 1, wherein:
the charity bundling site host computer requires in the user settings only: the donor's email, one or more names of donor's charity setting and one or more donor's pledged amount setting.

3. The method for electronic processing of EFTs for charity donations of claim 1, wherein: the charity bundling site host computer requires that the user set only: the donor's email, one or more names of donor's charity setting and one or more donor's pledged amount setting.

4. The method for electronic processing of EFTs for charity donations of claim 1, further comprising the step of:
a. sending EFT instructions from the host computer of the calculated charity donation amounts from the trust account bank account as one electronic fund transfer for each charity after a predetermined number of days.

5. The method for electronic processing of EFTs for charity donations of claim 1, further comprising the step of: configuring the charity bundling site host computer to send a tax receipt to the user by electronic mail.

6. The method for electronic processing of EFTs for charity donations of claim 1, wherein the charity payee does not receive the user's email address.

7. A method for electronic processing of EFTs for charity donations comprising the steps of:
a. providing a welcome page on a CBS website receiving users arriving from a hyper link on a Bill Pay Site directing logged in and registered Bill Pay Site users to a CBS host computer, the link having information identifying the bill pay site to the CBS host computer;
b. providing an information page on a CBS website to receive user input settings comprising pledges and user email addresses, wherein user input settings are stored in a database;
c. instructing users to return to their Bill Pay Site to select CBS, wherein CBS is a registered payee on a Bill Pay Site;
d. receiving monthly pledges from users, wherein the payment amount is automatically entered for the user on the Bill Pay Site and stored on the Bill Pay Site computer;
e. calculating monthly charity donation amounts; and
f. sending one EFT to each payee charity.

8. The method for electronic processing of EFTs for charity donations of claim 7, wherein: the charity bundling site host computer requires in the user settings only: the donor's email, one or more names of donor's charity setting and one or more donor's pledged amount setting.

9. The method for electronic processing of EFTs for charity donations of claim 7, wherein: the charity bundling site host computer requires that the user set only: the donor's email, one or more names of donor's charity setting and one or more donor's pledged amount setting.

10. The method for electronic processing of EFTs for charity donations of claim 7, further comprising the step of: sending EFT instructions from the host computer of the calculated charity donation amounts from the trust account bank account as one electronic fund transfer for each charity after a predetermined number of days.

11. The method for electronic processing of EFTs for charity donations of claim 7, further comprising the step of: configuring the charity bundling site host computer to send a tax receipt to the user by electronic mail.

12. The method for electronic processing of EFTs for charity donations of claim 7, wherein the charity payee does not receive the user's email address.

13. The method for electronic processing of EFTs for charity donations of claim 7, further comprising the step of: configuring the host computer to generate and send one electronic bill per period per user to the Bill Pay Site according to the pledged amounts in the user settings;
